(19) United States
(12) Patent Application Publication
(10) Pub. No.: US 2016/0129578 A1
(43) Pub. Date: May 12, 2016

(54) Device for Operating a Hand-Held Machine Tool

(71) Applicant: ROBERT BOSCH GMBH, Stuttgart (DE)

(72) Inventors: Helge Sprenger, Stuttgart (DE); Juergen Lennartz, Ostfildern (DE); Christian Bertsch, Markgroeningen (DE); Achim Duesselberg, Kirchheim/Teck (DE)

(21) Appl. No.: 14/895,236

(22) PCT Filed: Jun. 11, 2014
(86) PCT No.: PCT/EP2014/062081

§ 371 Date: Dec. 2, 2015

(30) Foreign Application Priority Data
Jun. 28, 2013 (DE) 10 2013 212 546.1

(51) Int. Cl. B25F 5/00; B25D 16/00

(52) U.S. Cl. CPC B25F 5/001; B25D 16/006

(57) ABSTRACT

A manual power tool operating device includes at least one control and regulating unit configured to drive a manual power tool drive unit. The manual power tool further includes at least one operating mode selection element configured to adjust a plurality of operating modes. The at least one control and regulating unit includes at least one operating program configured to be as a function of at least one signal of the operating mode selection element. The at least one operating program configured to at least one of modify and adjust at least two operating parameters characterizing at least one operating mode.

### PRIOR ART

Manual power tool operating devices having at least one control and/or regulating unit for driving a manual power tool drive unit and at least one operating mode selection element for adjusting various operating modes have already been proposed.

### DISCLOSURE OF THE INVENTION

The invention is based on a manual power tool operating device having at least one control and/or regulating unit for driving a manual power tool drive unit and having at least one operating mode selection element for adjusting various operating modes.

It is proposed that the control and/or regulating unit should comprise at least one operating program which is intended, as a function of at least one signal of the operating mode selection element, to modify/adjust at least two operating parameters characterizing at least one operating mode. A “control and/or regulating unit” is intended, in particular, to mean a unit with at least one set of control electronics. “Control electronics” are intended in particular to mean a unit having a processor unit and having a memory unit, as well as having an operating program stored in the memory unit. A “manual power tool drive unit” is in this case intended, in particular, to mean a drive unit, preferably a motor, in particular an electric motor, which drives a tool holder of the manual power tool. And “operating mode selection element” is in this case intended, in particular, to mean an element by means of which a defined operating mode of the manual power tool can be selected. In this case, the operating mode selection element is to be distinguished in particular from an operating element of the manual power tool, by means of which the manual power tool can be switched on and off. The operating mode selection element is in this case preferably configured as an element which can be adjusted mechanically by a user in order to adjust an operating mode. In principle, however, it is also conceivable for the operating mode selection element to be configured as an operating program of the control and/or regulating unit, and for the operating mode to be adjusted/modified for example with the aid of sensor data, for example tool identification. A “signal of the operating mode selection element” is in this case intended, in particular, to mean an electric and/or electronic signal, which is output by the operating mode selection element and is interpreted accordingly by the control and/or regulating unit in order to adjust an operating mode. An “operating mode” is in this case intended, in particular, to mean a mode in which the manual power tool can be operated for particular tasks, an operating mode being characterized by a plurality of operating parameters. In this case, the operating modes may be defined by merely two operating parameters or by more than 3 operating parameters. The manual power tool is in this case preferably adjusted optimally in an operating mode for a task desired by the user, for example “knocking out tiles” or “drilling into steel”. “In order to adjust an operating mode” is in this case intended, in particular, to mean that the operating mode selection element is intended to adjust an operating mode, or that an operating mode can be adjusted by means of the operating mode selection element. In this case, the operating mode selection element is configured as a control element, by means of which a user can select a corresponding operating mode. In principle, it is also conceivable for the operating mode selection element to be configured as an operating program stored in the control and/or regulating unit which selects an operating mode automatically, without intervention by a user, with the aid of input signals, for example from sensors, such as in particular tool holder sensors which identify a tool clamped in a tool holder of the manual power tool. An “operating parameter” is in this case intended to mean a parameter describing a working intensity of the manual power tool, in particular the rotation speed and/or a profile of the rotation speed of the manual power tool drive device. “Intended” is intended, in particular, to mean specially programmed, configured and/or equipped. That an object is intended for a particular function is intended, in particular, to mean that the object fulfills and/or executes this particular function in at least one application and/or operating state. “Modifying/adjusting operating parameters” is in this case intended, in particular, to mean that an operating parameter is set to an optimal value or profile for the corresponding operating mode when a particular operating mode is selected by means of the operating mode selection element. In this way, various operating modes can be adjusted particularly straightforwardly and advantageously by means of an operating mode selection element. In particular, it is straightforward for a user to adjust the manual power tool optimally for a desired task, without having to know the effect of the various operating parameters on the performance of the manual power tool for the desired task.

It is furthermore proposed that one of the operating parameters should be configured as an idling rotation speed. An “idling rotation speed” is in this case intended, in particular, to mean a rotation speed which the manual power tool drive unit has in an operating state in which a user has set the manual power tool drive unit in operation by means of an operating element of the manual power tool, but the manual power tool is not yet applied, i.e. a tool fitted in the manual power tool has not yet been placed at the corresponding position for processing. In this way, the idling rotation speed can advantageously be adjusted for various operating modes.

It is furthermore proposed that one of the operating parameters should be configured as a working rotation speed. A “working rotation speed” is in this case intended, in particular, to mean a rotation speed which the manual power tool drive unit has in an operating state in which a user has set the manual power tool drive unit in operation by means of an operating element of the manual power tool, and the manual power tool is applied, i.e. the tool fitted in the manual power tool has been placed at the corresponding position for processing and is in use. In this way, the working rotation speed can advantageously be adjusted for various operating modes.

It is also proposed that one of the operating parameters should be configured as a startup ramp. A “startup ramp” is in this case intended, in particular, to mean a profile of the rotation speed of the manual power tool drive unit between being at rest and the idling rotation speed. In this way, a profile between being at rest and the idling rotation speed of the manual power tool drive unit can advantageously be adjusted for various operating modes.

It is furthermore proposed that one of the operating parameters should be configured as an increasing ramp. An “increasing ramp” is in this case intended, in particular, to mean a profile of the rotation speed of the manual power tool drive unit between the idling rotation speed and the working rotation speed. In this way, a profile between the idling rotation speed and the drive rotation speed of the manual power tool drive unit can advantageously be adjusted for various operating modes.

It is furthermore proposed that one of the operating parameters should be configured as a decreasing ramp. A “decreasing ramp” is in this case intended, in particular to mean a profile of the rotation speed of the manual power tool drive unit between the working rotation speed and the idling rotation speed. In this way, a profile between the drive rotation speed and the idling rotation speed of the manual power tool drive unit can advantageously be adjusted for various operating modes.

It is also proposed that least at one parameter set should be stored in the control and/or regulating unit for each operating mode. A “parameter set” is in this case intended, in particular, to mean a value stored in the memory unit of the control and/or regulating unit for an operating mode. In this case, a corresponding value or a corresponding profile is stored in a parameter set for an operating mode for all operating parameters characterizing the corresponding operating mode. In this way, the operating parameters for an operating mode can be stored in the control and/or regulating unit in such a way that they can be called up particularly straightforwardly and advantageously.

It is furthermore proposed that a parameter set should have a value for each operating parameter characterizing the corresponding operating mode. “Having a value” is in this case intended, in particular, to mean that data for each operating parameter characterizing the corresponding operating mode are stored in the corresponding parameter set in the memory unit of the control and/or regulating unit. In this way, a parameter set can characterize an operating mode particularly straightforwardly and advantageously.

The manual power tool operating device according to the invention is in this case not intended to be restricted to the application and embodiment described above. In particular, the manual power tool operating device may have a number other than the number of individual elements, components and units mentioned here in order to fulfill a functionality described here.

### DRAWINGS

Further advantages may be found in the following description of the drawings. An exemplary embodiment of the invention is represented in the drawings. The drawing, the description and the claims contain numerous features in combination. The person skilled in the art will also expediently consider the features individually and combine them to form other appropriate combinations.

FIG. 1 shows a schematically represented manual power tool having a manual power tool operating device according to the invention,

FIG. 2 shows a coordinate system which shows various profiles of an operating parameter configured as a startup ramp,

FIG. 3 shows a coordinate system which shows various profiles of an operating parameter configured as an increasing ramp,

FIG. 4 shows a coordinate system which shows various profiles of an operating parameter configured as a decreasing ramp,

FIG. 5 shows a coordinate system which shows an exemplary profile of a rotation speed of a manual power tool drive unit.

### DESCRIPTION OF THE EXEMPLARY EMBODIMENT

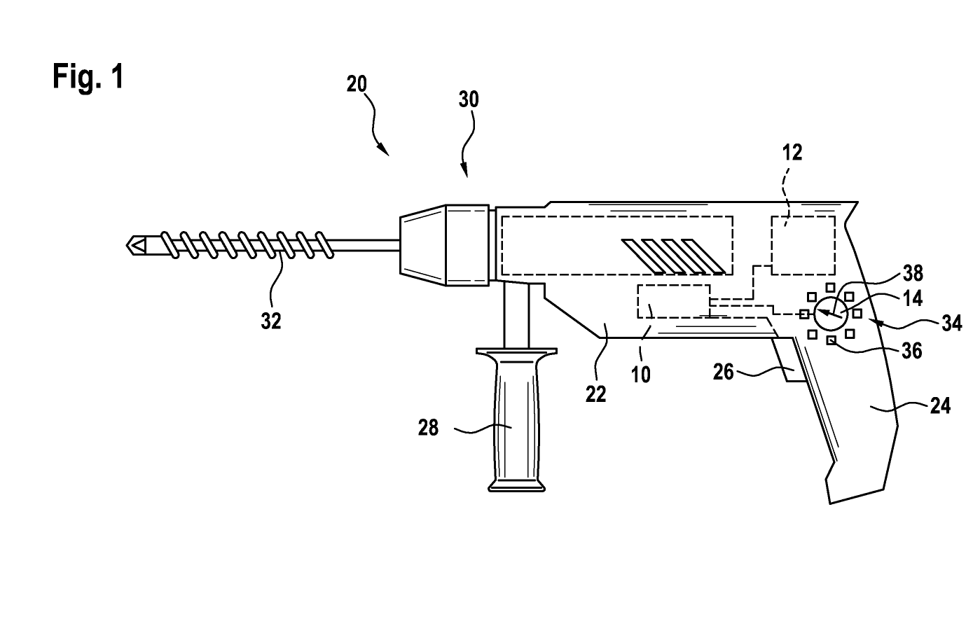

FIG. 1 shows a manual power tool 20 having a manual power tool operating device according to the invention. The manual power tool 20 is configured as a hammer drill. The manual power tool 20 configured as a hammer drill has a pistol-shaped tool housing 22, in which a manual power tool impact mechanism is arranged. A handle 24 with an operating element 26 is also arranged on the tool housing 22. The manual power tool 20 also has an additional handle 28 in order to improve the handling of the manual power tool 20. In principle, it is also conceivable for the manual power tool 20 to have a differently configured tool housing 22 which seems appropriate to the person skilled in the art. The manual power tool 20 comprises a tool holder 30, which is intended to hold a tool 32 for the manual power tool 20. In FIG. 1, the manual power tool 20 is represented with an exemplary tool 32, which is coupled to the manual power tool 20 by means of the tool holder 30. For driving the tool 32 clamped in the manual power tool 20, the manual power tool 20 comprises a manual power tool drive unit 12. In order to control the manual power tool drive unit 12, the manual power tool operating device comprises a control and regulating unit 10. The control and regulating unit 10 is intended for electronic driving of the manual power tool drive unit 12. In this case, the control and regulating unit 10 drives the manual power tool drive unit 12 by means of electrical and/or electronic output signals. The control and regulating unit 10 has a memory unit. Data can be stored electronically in the memory unit of the control and regulating unit 10.

The manual power tool operating device comprises an operating mode selection element 14. By means of the operating mode selection element 14, various operating modes can be adjusted by a user. The operating modes respectively represent predefined working procedures of the manual power tool 20. The various operating modes may in this case be “knocking out tiles”, “breaking concrete”, “flat chiseling”, “chiseling on hollow bricks”, “drilling into reinforced concrete”, “drilling into bricks”, “drilling into aerated concrete” or designated by means of a different descriptive title. In this case, the operating modes are preferably designated in such a way that their designation descriptively matches the task preferably carried out in the operating mode. In principle, other designations for the operating modes may naturally also be envisioned, for example “clean”, “fast”, “maximum removal” or alternatively other designations which seem appropriate to the person skilled in the art. The operating mode selection element 14 is in this case configured as an adjustment wheel. The operating mode selection element 14 configured as an adjustment wheel is rotatable and has a plurality of switching positions. Each switching position of the adjustment wheel is assigned an operating mode. The operating mode selection element 14 outputs a signal according to the position of the operating mode selection element 14. The signal output by the operating mode selection element 14 is in this case configured as an electrical signal, which is respectively output by the operating mode selection element 14 when changing from one switching position to another switching position. In principle, it is also conceivable for the operating mode selection element 14 to output a different signal which seems appropriate to the person skilled in the art, or for the operating mode selection element 14 to model a signal fed into the operating mode selection element 14 differently according to the switching position. In this way, the operating mode selection element 14 outputs a different signal according to the switching position. In order to signal the operating mode which is adjusted by means of the operating mode selection element 14, the manual power tool operating device has an output unit 34. The output unit outputs a signal to a user, by means of which he can identify which operating mode is selected by means of the operating mode selection element 14. The output unit 34 is in this case configured as a visual output unit. The output unit 34 is in this case formed by symbols 36 arranged around the operating mode selection element 14 configured as an adjustment wheel and an arrow arranged on the operating mode selection element 14 configured as an adjustment wheel; in a switching position in which a particular operating mode is switched on, the arrow 38 points in the direction of the symbol 36 that is assigned to the corresponding operating mode.

The operating modes are respectively characterized by a plurality of operating parameters. In this case, an operating mode may be characterized by merely two operating parameters or more than two operating parameters. A first operating parameter is in this case configured as an idling rotation speed 16. The first operating parameter, configured as an idling rotation speed 16, in this case indicates a rotation speed of the manual power tool drive unit 12 which the manual power tool drive unit 12 has in an operating state in which the manual power tool 20 is actuated by the user by means of the operating element 26 but the tool 32 is not yet in a working position. The second operating parameter is configured as a working rotation speed 18. The second operating parameter, configured as a working rotation speed 18, in this case indicates a rotation speed of the manual power tool drive unit 12 which the manual power tool drive unit 12 has in an operating state in which the manual power tool 20 is actuated by the user by means of the operating element 26 and the tool 32 is in a working position.

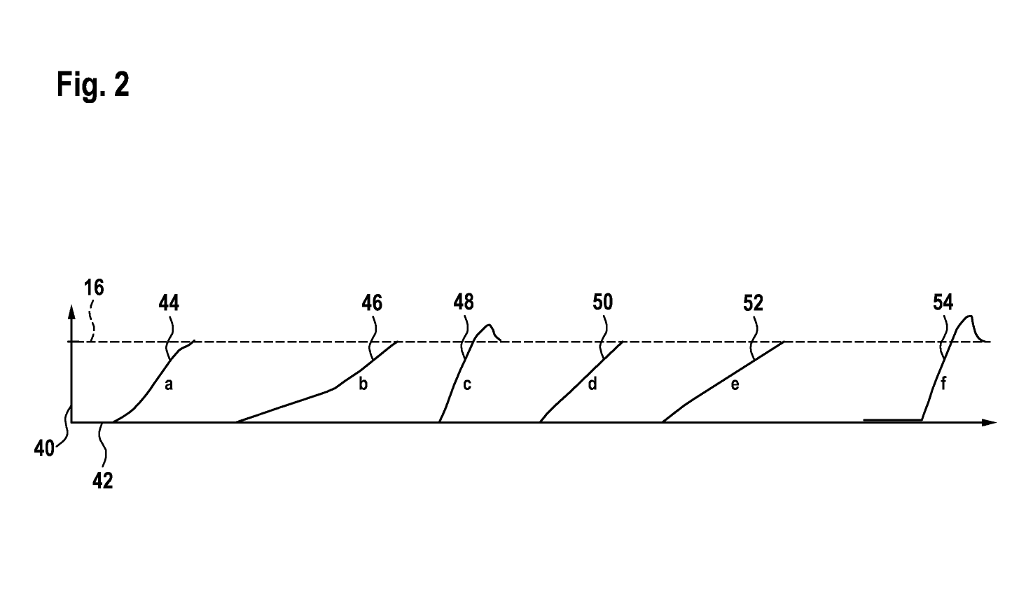

The third operating parameter is configured as a startup ramp. The third operating parameter, configured as a startup ramp, indicates a profile of the rotation speed of the manual power tool drive unit 12 between the zero rotation speed, i.e. the manual power tool drive unit 12 being stationary, and the idling rotation speed 16 of the manual power tool drive unit 12. By means of the profile indicated by the third operating parameter, configured as a startup ramp, when the operating element 26 is actuated by a user, the manual power tool drive unit 12 increases the rotation speed of the manual power tool drive unit 12 from 0 to the idling rotation speed 16. A plurality of profiles for the third operating parameter, configured as a startup ramp, are in this case stored in the control and regulating unit 10. Six profiles of the startup ramp are in this case stored in the control and regulating unit 10. FIG. 2 in this case schematically shows the six different profiles for the third operating parameter, configured as a startup ramp. In this case, FIG. 2 represents a coordinate system in which the setpoint rotation speed of the manual power tool drive unit 12 is plotted on the abscissa 40 and the time is plotted on the ordinate 42. The idling rotation speed 16 of the manual power tool drive unit 12 is in this case shown on the abscissa of the coordinate system represented. As a first profile, the startup ramp a 44, which describes a rapid increase in the rotation speed of the manual power tool drive unit 12 from 0 to the idling rotation speed 16, is stored in the control and regulating unit 10. In this case, the rotation speed of the manual power tool drive unit 12 increases nonlinearly in the startup ramp a 44.

As a second profile, the startup ramp b 46 is stored, which describes a gentle startup of the manual power tool drive unit 12, i.e. a slower increase in the rotation speed of the manual power tool drive unit 12 from being stationary to the idling rotation speed 16. As a third profile, the startup ramp c 48 is stored, which describes an increase of the rotation speed of the manual power tool drive unit 12 which is as fast as possible from being stationary to the idling rotation speed 16. In this case, the profile of the startup ramp c 48 has an overshoot, so that the rotation speed of the manual power tool drive unit 12 overshoots by 20% beyond the idling rotation speed 16 before the idling rotation speed 16 is finally reached. In principle, it is in this case also conceivable for the profile of the startup ramp c 48 to overshoot beyond the idling rotation speed 16 by a different value. Furthermore, FIG. 2 represents three further profiles, startup ramp d 50 in which the rotation speed increases linearly, startup ramp e 52, which likewise shows an increase in the rotation speed which is linear but is shallower than the startup ramp d 50, and startup ramp f 54 which has a delay time in which the rotation speed initially does not increase, and a subsequent increase which is as rapid as possible in the rotation speed to the idling rotation speed 16 with an overshoot takes place. In principle, it is also conceivable for further profiles of the operating parameter configured as a startup ramp to be stored in the control and regulating unit 10.

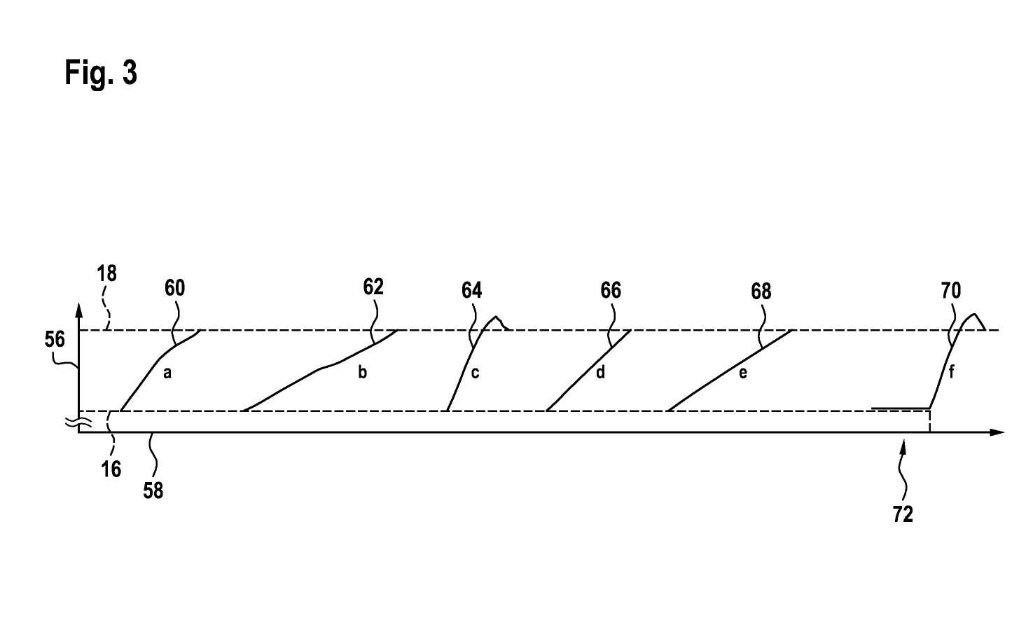

The fourth operating parameter is configured as an increasing ramp. The fourth operating parameter, configured as an increasing ramp, indicates a profile of the rotation speed of the manual power tool drive unit 12 between the idling rotation speed 16 and the working rotation speed 18 of the manual power tool drive unit 12. In this case, the profiles of the operating parameter configured as an increasing ramp are configured essentially equivalently to the profiles of the operating parameters configured as startup ramps. A plurality of profiles of the fourth operating parameter, configured as an increasing ramp, are in this case stored in the control and regulating unit 10. Six profiles of the increasing ramp are in this case stored in the control and regulating unit 10. FIG. 3 in this case schematically shows the six different profiles of the fourth operating parameter, configured as an increasing ramp. In this case, FIG. 3 represents a coordinate system in which the setpoint rotation speed of the manual power tool drive unit 12 is plotted on the abscissa 56 and the time is plotted on the ordinate 58. The idling rotation speed 16 and the drive rotation speed of the manual power tool drive unit 12 are in this case shown on the abscissa of the coordinate system represented. As a first profile, the increasing ramp a 60, which describes a rapid increase in the rotation speed of the manual power tool drive unit 12 from the idling rotation speed 16 to the drive rotation speed, is stored in the control and regulating unit 10. In this case, the rotation speed of the manual power tool drive unit 12 increases nonlinearly in the increasing ramp a 60. As a second profile, the increasing ramp b 62 is stored, which describes a gentle increase of the manual power tool drive unit 12, i.e. a slower increase in the rotation speed of the manual power tool drive unit 12 from the idling rotation speed 16 to the working rotation speed 18. As a third profile, the increasing ramp c 64 is stored, which describes an increase of the rotation speed of the manual power tool drive unit 12 which is as fast as possible from the idling rotation speed 16 to the working rotation speed 18. In this case, the profile of the increasing ramp c 64 has an overshoot, so that the rotation speed of the manual power tool drive unit 12 overshoots by 20% beyond the drive rotation speed before the drive rotation speed is finally reached. In principle, it is in this case also conceivable for the profile of the increasing ramp c 64 to overshoot beyond the drive rotation speed by a different value. Furthermore, FIG. 3 represents three further profiles, increasing ramp d 66 in which the rotation speed increases linearly, increasing ramp e 68, which likewise shows an increase in the rotation speed which is linear but is shallower than the increasing ramp d 66, and increasing ramp f 70 which has a delay time 72 in which the rotation speed initially does not increase, and a subsequent increase which is as rapid as possible in the rotation speed to the working rotation speed 18 with an overshoot takes place. In principle, it is also conceivable for further profiles of the operating parameter configured as an increasing ramp to be stored in the control and regulating unit 10.

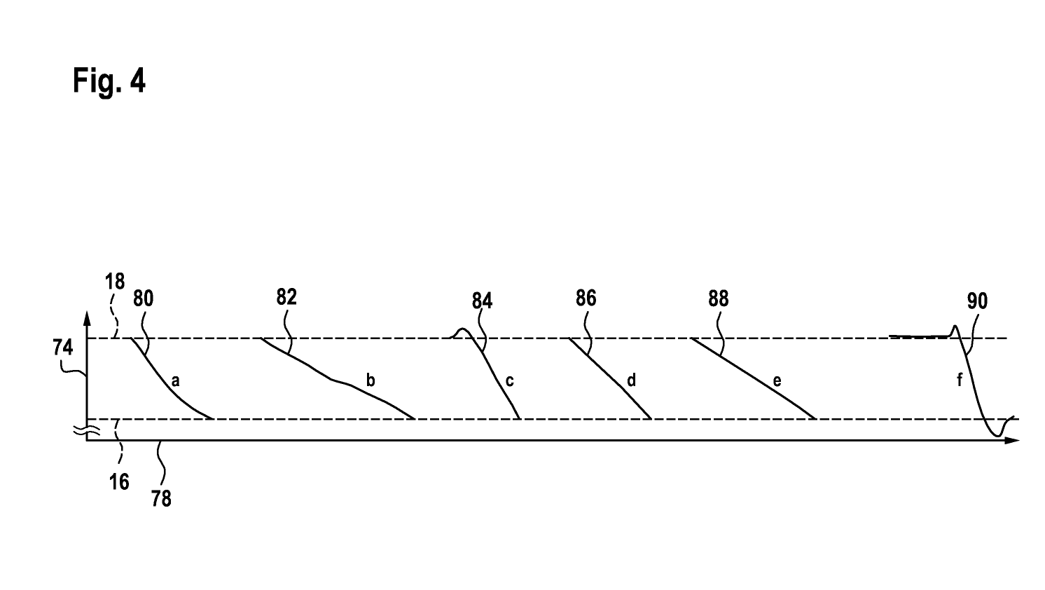

The fifth operating parameter is configured as a decreasing ramp. The fifth operating parameter, configured as a decreasing ramp, indicates a profile of the rotation speed of the manual power tool drive unit 12 from the working rotation speed 18 to the idling rotation speed 16 of the manual power tool drive unit 12. A plurality of profiles of the fifth operating parameter, configured as a decreasing ramp, are stored in the control and regulating unit 10. Six profiles of the decreasing ramp are in this case stored in the control and regulating unit 10. FIG. 4 in this case schematically shows the six different profiles of the fifth operating parameter, configured as a decreasing ramp. In this case, FIG. 4 represents a coordinate system in which the setpoint rotation speed of the manual power tool drive unit 12 is plotted on the abscissa 74 and the time is plotted on the ordinate 78. The idling rotation speed 16 and the drive rotation speed of the manual power tool drive unit 12 are in this case shown on the abscissa of the coordinate system represented. As a first profile, the decreasing ramp a 80, which describes a rapid decrease in the rotation speed of the manual power tool drive unit 12 from the working rotation speed to the idling rotation speed 16, is stored in the control and regulating unit 10. In this case, the rotation speed of the manual power tool drive unit 12 decreases nonlinearly in the decreasing ramp a 80. As a second profile, the decreasing ramp b 82 is stored, which describes a slow decrease in the rotation speed of the manual power tool drive unit 12 from the working rotation speed 18 to the idling rotation speed 16. As a third profile, the decreasing ramp c 84 is stored, which describes a decrease in the rotation speed of the manual power tool drive unit 12 which is as fast as possible from the working rotation speed 18 to the idling rotation speed 16. In this case, the profile of the decreasing ramp c 84 has a brief increase in the rotation speed at the start, so that before the decrease of the working rotation speed 18, the rotation speed of the manual power tool drive unit 12 overshoots by 20% beyond the working rotation speed 18 before it then decreases as rapidly as possible to the idling rotation speed 16. In principle, it is in this case also conceivable for the profile of the decreasing ramp c 84 to increase beyond the working rotation speed by a different value. Furthermore, FIG. 4 represents three further profiles, decreasing ramp d 86 in which the rotation speed decreases linearly, decreasing ramp e 88, which likewise shows a decrease in the rotation speed which is linear but is shallower than the decreasing ramp d 86, and decreasing ramp f 90 which has a delay time in which the rotation speed initially remains constant, followed by a subsequent brief rise in the rotation speed, and a decrease which is as rapid as possible to the idling rotation speed 16, with an undershoot of the rotation speed below the idling rotation speed 16. In principle, it is also conceivable for further profiles of the operating parameter configured as a decreasing ramp to be stored in the control and regulating unit 10.

The control and regulating unit 10 has an operating program. The operating program is in this case stored in the memory unit of the control and regulating unit 10. The operating program is intended to adjust or modify at least two operating parameters characterizing an operating mode as a function of the signal of the operating mode selection element 14. In this case, according to the signal of the operating mode selection element 14, the control and regulating unit 10 alters two, three, four or all five operating parameters which define an operating mode. In principle, it is naturally also conceivable for an operating mode to be defined by further operating parameters, i.e. more than five operating parameters, and for the control and regulating unit 10 therefore to alter or adjust more than five operating parameters when a user selects an operating mode by means of the operating mode selection element 14. In principle, it is also conceivable for one or more of the operating parameters to be set at a defined value for all operating modes, i.e. for it to remain unchanged when switching to another operating mode. When a particular operating mode is adjusted by means of the operating mode selection element 14, the control and regulating unit 10 adjusts a defined value for the first operating parameter, configured as an idling rotation speed 16. When a particular operating mode is adjusted by means of the operating mode selection element 14, the control and regulating unit 10 adjusts a defined value for the second operating parameter, configured as a working rotation speed 18. When a particular operating mode is adjusted by means of the operating mode selection element 14, the control and regulating unit 10 adjusts a particular profile for the third operating parameter, configured as a startup ramp. When a particular operating mode is adjusted by means of the operating mode selection element 14, the control and regulating unit 10 adjusts a particular profile for the fourth operating parameter, configured as an increasing ramp. When a particular operating mode is adjusted by means of the operating mode selection element 14, the control and regulating unit 10 adjusts a particular profile for the fifth operating parameter, configured as a decreasing ramp.

Stored in the memory unit of the control and regulating unit 10 for the operating modes, which can be adjusted by means of the operating mode selection unit 14, there are parameter sets which respectively assign a particular value of the operating parameters to each operating mode. In this case, a parameter set respectively assigns a value or a profile in a particular operating mode to the operating parameters characterizing the operating mode.

The parameter set for the operating mode “knocking out tiles” in this case adjusts the first parameter, configured as an idling rotation speed 16, to a rotation speed of 2000 rpm. Furthermore, the parameter set for the operating mode “knocking out tiles” adjusts the second operating parameter configured as a drive rotation speed to a rotation speed of 2500 rpm. For the operating mode “knocking out tiles”, the parameter set adjusts the third operating parameter, configured as a startup ramp, to the startup ramp a 44. For the operating mode “knocking out tiles”, the parameter set adjusts the fourth operating parameter, configured as an increasing ramp, to the increasing ramp c 64. For the operating mode “knocking out tiles”, the parameter set adjusts the fifth operating parameter, configured as a decreasing ramp, to the decreasing ramp c 84. For the operating mode “breaking concrete”, the parameter set adjusts the first operating parameter, configured as an idling rotation speed 16, to a rotation speed of 3000 rpm, the second operating parameter, configured as a drive rotation speed, to a rotation speed of 3400 rpm, the third operating parameter, configured as a startup ramp, to the startup ramp a 44, the fourth operating parameter, configured as an increasing ramp, to the increasing ramp a 60, and the fifth operating parameter, configured as a decreasing ramp, to the decreasing ramp a 80. The table below shows the parameter sets described above and further parameter sets which are stored in the control and regulating unit 10. The parameter sets indicated in the table, and therefore the operating modes of the manual power tool 20 which can be adjusted by the operating mode selection element 14, are in this case indicated merely by way of example. In principle, any other operating modes, and therefore parameter sets stored therefor on the control and regulating unit 10, which a person skilled in the art considers as appropriate, may be envisioned. In this case, it is likewise not necessary that the manual power tool 20 must be able to carry out all operating modes indicated in the table, and therefore that all these parameter sets should be stored in the control and regulating unit 10.

| | Idling | Working | | | |
|---|---|---|---|---|---|
| Parameter | rotation | rotation | Startup | Increasing | Decreasing |
| set | speed | speed | ramp | ramp | ramp |
| Knocking | 2000 rpm | 2500 rpm | startup | increasing | decreasing |
| out tiles | | | ramp a | ramp c | ramp c |
| Breaking | 3000 rpm | 3400 rpm | startup | increasing | decreasing |
| concrete | | | ramp a | ramp a | ramp a |
| Flat | 1400 rpm | 2000 rpm | startup | increasing | decreasing |
| chiseling | | | ramp b | ramp e | ramp b |
| Chiseling | 2800 rpm | 3000 rpm | startup | increasing | decreasing |
| on hollow | | | ramp d | ramp b | ramp a |
| bricks | | | | | |
| Drilling | 2800 rpm | 3000 rpm | startup | increasing | decreasing |
| into | | | ramp a | ramp f | ramp d |
| reinforced | | | | | |
| concrete | | | | | |
| Drilling | 2500 rpm | 2800 rpm | startup | increasing | decreasing |
| into | | | ramp b | ramp b | ramp a |
| bricks | | | | | |
| Drilling | 2000 rpm | 2500 rpm | startup | increasing | decreasing |
| into | | | ramp d | ramp d | ramp b |
| aerated | | | | | |
| concrete | | | | | |

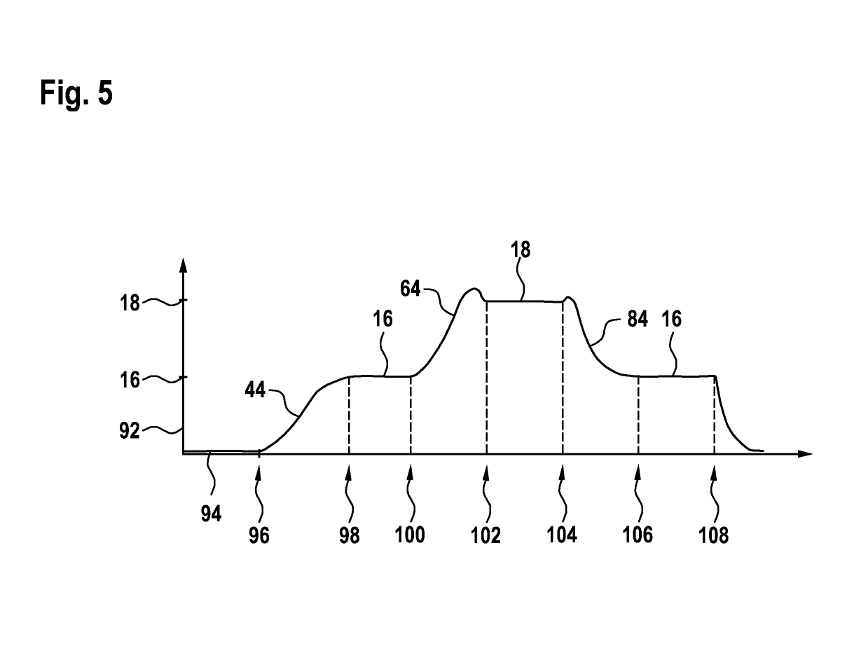

FIG. 5 shows by way of example a profile of a rotation speed of the manual power tool drive unit 12, the operating mode “knocking out tiles” being adjusted by means of the operating mode selection element 14, and the corresponding parameter set for driving the manual power tool drive unit 12 therefore having been selected by the control and regulating unit 10. In this case, FIG. 5 represents a coordinate system in which the setpoint rotation speed of the manual power tool drive unit 12 is plotted on the abscissa 92 and the time is plotted on the ordinate 94. In this case, the idling rotation speed 16 adjusted in the operating mode “knocking out tiles” of 2000 rpm and the adjusted working rotation speed 18 of 2500 rpm for the manual power tool drive unit 12 are indicated on the abscissa 92 of the coordinate system represented. Initially, the manual power tool 20 is still in a standby state and the manual power tool drive unit 12 has a rotation speed of 0. At a first instant 96, the manual power tool 20 is switched on by a user by actuating the operating element 26, and the rotation speed increases via the startup ramp a 44 selected by the control and regulating unit 10 for this operating mode to the idling rotation speed 16. At a second instant 98, the rotation speed of the manual power tool drive unit 12 has reached the idling rotation speed 16 and remains there, since the manual power tool 20 is initially not being applied, i.e. placed with its tool on the workpiece. At a third instant 100, the manual power tool 20 is applied, so that for example the manual power tool impact mechanism of the manual power tool 20 is also started and the rotation speed of the manual power tool drive unit 12 increases via the increasing ramp c 64 selected by the control and regulating unit 10 for this operating mode from the idling rotation speed 16 to the adjusted working rotation speed 18. At a fourth instant 102, the rotation speed of the manual power tool drive unit 12 has then reached the working rotation speed 18. The manual power tool 20 remains applied until a fifth instant 104, the user thus working between the fourth instant 102 and the fifth instant 104. At the fifth instant 104, the user removes the manual power tool 20 and the rotation speed of the manual power tool drive unit 12 decreases via the decreasing ramp c 84 adjusted by the control and regulating unit 10 for the operating mode “knocking out tiles” from the working rotation speed 18 to the idling rotation speed 16. Beyond a sixth instant 106, the rotation speed of the manual power tool drive unit 12 has decreased to the idling rotation speed 16 and continues at the idling rotation speed 16 until a seventh instant 108, since the user continues to actuate the operating element 26 in a retracted state of the manual power tool 20. At the seventh instant 108, the user ceases to actuate the operating element 26, and the manual power tool is switched off. The rotation speed of the manual power tool drive unit 12 in this case decreases after the seventh instant 108 until the manual power tool drive unit 12 is at rest. The profile of the rotation speed represented in FIG. 5 is in this case only an example which is brought about by the operating element 26 for intended operation of the manual power tool 20 when the operating mode “knocking out tiles” is adjusted by the operating mode selection element 14. By different operation as a function of time by means of the operating element 26, a profile would correspondingly appear differently, a transition between the idling rotation speed 16 and the working rotation speed 18 respectively having been followed by means of the operating parameter adjusted by the control and regulating unit 10. In a different operating mode selected by the operating mode selection unit 14, the operating parameters would be adapted accordingly and transitions between the idling rotation speed 16 and the working rotation speed 18, as well as the actual values of the idling rotation speed 16 and the working rotation speed 18, would be configured correspondingly.

1. A manual power tool operating device having comprising:
at least one control and regulating unit configured to drive a manual power tool drive unit;
at least one operating mode selection element configured to adjust a plurality of operating modes,
wherein the at least one control and regulating unit includes at least one operating program configured to be a function of at least one signal of the operating mode selection element,
the at least one operating program configured to at least one of modify and adjust at least two operating parameters characterizing at least one operating mode.

2. The manual power tool operating device as claimed in claim 1, wherein one of the operating parameters is an idling rotation speed.

3. The manual power tool operating device as claimed in claim 1, wherein one of the operating parameters is a working rotation speed.

4. The manual power tool operating device as claimed in claim 1, wherein one of the operating parameters is a startup ramp.

5. The manual power tool operating device as claimed in claim 1, wherein one of the operating parameters is an increasing ramp.

6. The manual power tool operating device as claimed in claim 1, wherein one of the operating parameters is a decreasing ramp.

7. The manual power tool operating device as claimed in claim 1, wherein at least one parameter set is stored in the at least one control and regulating unit for each operating mode.

8. The manual power tool operating device as claimed in claim 7, wherein the at least one parameter set has a value for each operating parameter characterizing the corresponding operating mode.

9. A manual power tool comprising:
a manual power tool operating device including
at least one control and regulating unit configured to drive a manual power tool drive unit;
at least one operating mode selection element configured to adjust a plurality of operating modes,
wherein the at least one control and regulating unit includes at least one operating program configured to be a function of at least one signal of the operating mode selection element,
the at least one operating program configured to at least one of modify and adjust at least two operating parameters characterizing at least one operating mode.

10. A method for operating a manual power tool including a manual power tool operating device having at least one operating mode selection element configured to adjust a plurality of operating modes, the method comprising:
at least one of modifying and adjusting at least two operating parameters as a function of at least one signal of the operating mode selection element, wherein the at least two operating parameters characterize at least one operating mode.
